(19) United States
(12) Patent Application Publication
(10) Pub. No.: US 2008/0210751 A1
(43) Pub. Date: Sep. 4, 2008

(54) System And Method For Transferring Money Based On Approval Of Transfer Request Transmitted From Receiver To Sender

(76) Inventor: Young-Su Kim, Uljin-Gun Gyeongsangbuk-do (KR)

Correspondence Address: IPLA P.A., 3580 WILSHIRE BLVD., 17TH FLOOR, LOS ANGELES, CA, 90010, US

(21) Appl. No.: 11/908,057

(22) PCT Filed: Mar. 21, 2006
(86) PCT No.: PCT/KR06/01032

§ 371 Date: Sep. 7, 2007

(30) Foreign Application Priority Data
Mar. 21, 2005 (KR) 10-2005-0023320
Mar. 21, 2006 (KR) PCT/KR06/01032

(51) Int. Cl. G06Q 40/00

(52) U.S. Cl. 235/379; 705/42

(57) ABSTRACT

A money transfer system transfers money based on approval of a sender for a transfer request transmitted from a receiver. This system includes a receiver terminal for transferring transfer request information including receiving information and sending information; a bank server for extracting the sending information from the transfer request information to guide the transfer request information to a sender, and transferring an amount of money from a payment account of the sender to a deposit account when the sender checks the transfer request information and approves the money transfer; and a sender terminal for accessing the bank server to receive and display the transfer request information, and transmitting an approval for the money transfer to the deposit account. The sender determines whether or not to transfer money by checking the transfer request of the receiver, thereby reducing time taken for the money transfer process and enhancing accuracy and safety.

### TECHNICAL FIELD

The present invention relates to system and method for transferring money based on approval of a transfer request from a receiver by a sender, and more particularly to system and method for transferring money in which a receiver inputs receiving information and sending information for request money transfer, then a sender checks the transfer request and then approves money transfer, and then the money specified in the receiving information is transferred to the receiver.

### BACKGROUND ART

Money transfer is defined that a sender transfers a predetermined amount of money to a deposit account of a receiver from his/her own payment account. In recent years, a sender generally prefers on-line money transfer using Internet banking, phone banking, ATM banking and mobile banking, rather than actually visiting an off-line bank.

In case a conventional money transfer, a sender receives a transfer request including a receiver name and a deposit account number directly from a receiver off-line, and then the sender designates the receiver on-line or off-line to transfer money. In this process, the sender should personally input the receiver name and the account number of the receiver.

However, in the conventional money transfer, the sender should carefully input the account information of the receiver at every money transfer. It may cause the sender to transfer money to another person by a mistake, which inconveniently consumes time and cost for correcting the money transfer error for all of the sender, the receiver and the bank.

In particular, in case a person (or, a company) frequently makes money transfer, he/she should input receiver information at every money transfer, which requires significant attention and much time.

Similarly, when a receiver checks details of received money transfer, a sender name should be checked one by one. In addition, when money is transferred from different persons of the same name, a sender should be analogized based on the amount of money, or it is required to contact the sender directly so as to inquire about the money transfer.

### DISCLOSURE OF INVENTION

### Technical Problem

The present invention is designed in consideration of the above problems, and therefore it is an object of the invention to provide safe and rapid money transfer service, in which a receiver who will receive money by money transfer requests the money transfer to a specific sender first, and then the sender checks a requested amount of money to be paid to the receiver and then transfers money without direct input of receiver information.

### Technical Solution

In order to accomplish the above object, a first embodiment of the present invention provides a money transfer system for transferring money based on approval of a sender for a transfer request transmitted from a receiver on on-line banking (including Internet banking, phone banking, ATM (Automatic Teller Machine) banking and mobile banking), which includes a receiver terminal for transferring transfer request information including receiving information and sending information; a bank server for extracting the sending information from the transfer request information transmitted from the receiver terminal to guide the transfer request information to a corresponding sender, and transferring a predetermined amount of money from a payment account of the sender to a deposit account of the receiving information when the sender checks the transfer request information and approves the money transfer; and a sender terminal for accessing the bank server to receive and display the transfer request information of the receiver, and transmitting an approval for the money transfer to the deposit account of the receiver included in the transfer request information.

According to a second embodiment of the present invention, there is also provided a money transfer system for transferring money based on approval of a sender for a transfer request transmitted from the receiver, which includes a receiver terminal for transferring transfer request information including receiving information and sending information; a transfer request mediating server for guiding a receiver to join as a member, and extracting the sending information from the transfer request information transmitted from the receiver terminal logged in and mediating so that the transfer request information is transmitted to a payment bank of a corresponding sender; a bank server for extracting the sending information from the transfer request information transmitted from the transfer request mediating server to guide the transfer request information to the corresponding sender, and transferring a predetermined amount of money from a payment account of the sender to a deposit account of the receiving information when the sender checks the transfer request information and approves the money transfer; and a sender terminal for accessing the bank server to receive and display the transfer request information of the receiver, and transmitting an approval for the money transfer to the deposit account of the receiver included in the transfer request information.

In addition, a money transfer method for transferring money based on approval of a sender for a transfer request transmitted from a receiver on on-line banking (including Internet banking, phone banking, ATM banking and mobile banking) according to the first embodiment of the present invention includes (S11) a bank server receiving transfer request information including receiving information and sending information from a receiver terminal and storing the transfer request information in a transfer request information DB; (S12) the bank server generating a peculiar number based on inquiry of validity of the transfer request information, and transmitting the peculiar number to the receiver terminal; (S13) a sender terminal inquiring the transfer request information DB using all account numbers possessed by a sender when accessing the bank server so that details of the transfer request information are transmitted thereto; and (S14) transmitting a predetermined amount of money from a payment account of the sender to a deposit account of the receiving information the sender terminal in case the sender terminal selects and approves at least one transfer request.

According to the second embodiment of the present invention, there is also provided a money transfer method for transferring money based on approval of a sender for a transfer request transmitted from a receiver, which includes (S21) a transfer request mediating server processing a member subscription request from the receiver terminal, and storing member information and at least one receiver account information in a member information DB; (S22) the transfer request mediating server receiving transfer request information including receiving information and sending information from a logged-in receiver terminal, and storing the transfer request information in a transfer request information DB; (S23) extracting the sending information from the transfer request information, and transmitting the transfer request information to a bank server of a corresponding sender; (S24) receiving a peculiar number from the bank server, and informing the peculiar number to the receiver terminal as a result of transfer request registration; (S25) the bank server guiding the transfer request information to an accessed sender terminal to transfer money from the sender; and (S26) receiving a money transfer completion result for a specific peculiar number from the bank server, storing the completion result in the transfer request information DB, and informing the receiver terminal of the completion result.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic view showing a money transfer system according to a first embodiment of the present invention;

FIGS. 2 to 4 show a network interface of the money transfer system according to the first embodiment of the present invention.

FIGS. 5 and 6 are diagrams illustrating a money transfer process of a sender terminal in the money transfer system according to the first embodiment of the present invention;

FIG. 7 schematically shows an inner structure of a bank server according to the first embodiment of the present invention;

FIG. 8 is a schematic view showing a money transfer system according to a second embodiment of the present invention;

FIG. 9 schematically shows an inner structure of a transfer request mediating server according to the second embodiment of the present invention;

FIG. 10 is a flowchart illustrating an entire money transfer method according to the first embodiment of the present invention;

FIG. 11 is a detailed flowchart illustrating a transfer request information receiving process according to the first embodiment of the present invention;

FIG. 12 is a detailed flowchart illustrating a peculiar number generation and transmission step according to the first embodiment of the present invention;

FIG. 13 is a detailed flowchart illustrating a callback URL text message transmitting step of a back server according to the first embodiment of the present invention;

FIG. 14 is a flowchart illustrating an entire money transfer method according to the second embodiment of the present invention; and

FIG. 15 is a detailed flowchart illustrating a money transfer mediating step in the transfer request mediating server according to the second embodiment of the present invention.

### BEST MODE FOR CARRYING OUT THE INVENTION

Hereinafter, preferred embodiments of the present invention will be described in detail with reference to the accompanying drawings.

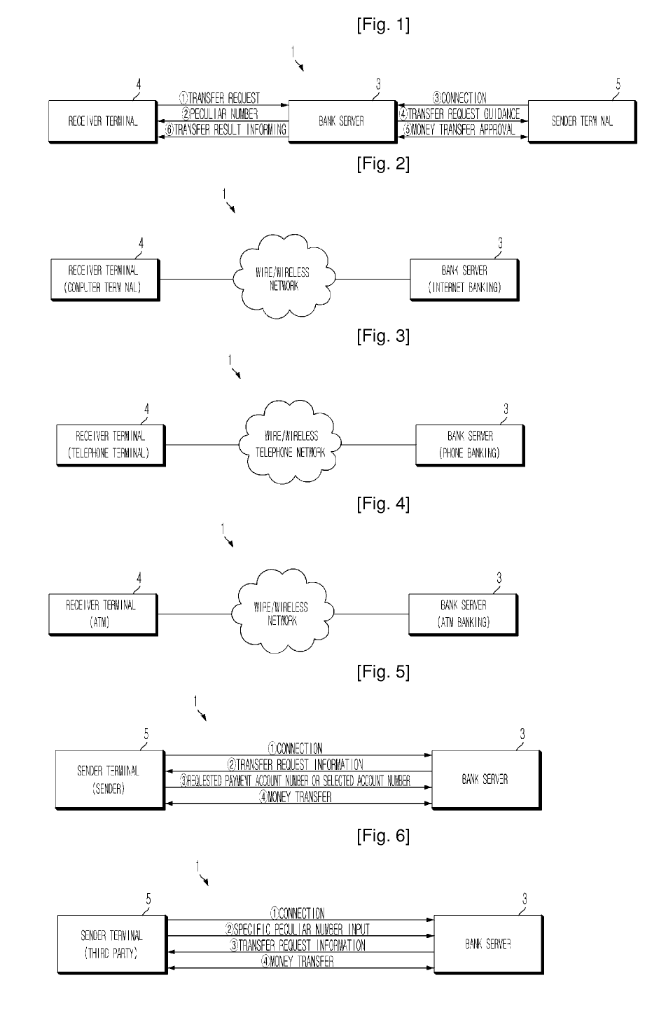

FIG. 1 shows a schematic configuration of a money transfer system 1 according to a first embodiment of the present invention.

The money transfer system 1 according to the first embodiment of the present invention includes a bank server 3, a receiver terminal 4 and a sender terminal 5. Such components are based on an on-line banking including Internet banking, phone banking, ATM banking and mobile banking used by a sender and a receiver.

The entire procedure of the money transfer system 1 is not described in brief. The bank server 3 receives transfer request information (receiving information and sending information) input by a receiver from the receiver terminal 4 (\textcircled{1}). The following table 1 shows an example of data included in the transfer request information, but not limitedly.

TABLE 1

| | |
|---|---|
| Transfer request | Receiving information: receiver name + |
| information | deposit bank name + deposit account number + |
| | amount for transfer + . . . Sending information: |
| | sender name + payment bank name + payment account |
| | number + |

In the above table 1, the receiving information and the sending information may include a phone number and an email address for contacting the receiver and the sender for being used as a user informing means, and a reason of payment (payment by installment, payment by purchase, charge for newspaper, public imposts and so on).

The bank server 3 conducts a validity test for extracting an account number and an account owner from the transmitted transfer request information and determining whether they are correct, and then endows a peculiar number (or, a peculiar identification number) for the transfer request to respond to the receiver terminal 4 in real time if the account information is accurate (\textcircled{2}). If the sender terminal 5 accesses the bank terminal 3 (\textcircled{3}), the transfer request information requested for the sender is guided (\textcircled{4}). The sender checks the receiver information and an amount of money to be transferred, and then selects at least one transfer request information and approves money transfer if it is determined that the money should be paid (\textcircled{5}). In addition, the bank server 3 draws a predetermined amount of money from a payment account of the sender and then transfers the money to a deposit account of the receiver, and then informs the receiver terminal 4 of a result.

The money transfer service by a transfer request according to the present invention allows a receiver to receive a money obtained after deducting a predetermined commission from the transferred money of a sender.

FIGS. 2 to 4 show a configuration of a network interface in the money transfer system 1 according to the first embodiment of the present invention. In FIGS. 2 to 4, a network interface for the receiver terminal 4 is exemplarily illustrated for convenience, and it is identically applied to the sender terminal 5.

The bank server 3 of the first embodiment provides money transfer service from a receiver (or, a sender) through a computer terminal, a telephone terminal, or an ATM device.

FIG. 2 shows a computer terminal (e.g., a desktop, a notebook, and a PDA) accessible to an Internet banking homepage via a wire/wireless network. In addition, in case of a mobile phone, a dedicated chip provided from a bank can be used for Internet banking through mobile banking service of each mobile communication service provider (e.g., M-bank). The Internet banking homepage of the bank server 3 provides a predetermined interface (or, an input page) so that a receiver may input transfer request information as shown in Table 1. FIG. 3 illustrates a telephone terminal accessible to a phone banking ARS via a PSTN or a mobile communication network. In addition, FIG. 4 illustrates the case that the receiver terminal 4 is an ATM terminal installed to a bank.

If a receiver transmits the transfer request information to the bank server 3 through the above process, the bank server 3 determines whether account owners and account numbers of a sender and a receiver included in the transfer request information are substantially identical as existing accounts, and then responds a peculiar number in real time.

In particular, the above peculiar number is an identification number for checking money transfer. A receiver may check that a requested money is received by means of the identification number though the money is received from a person or an account different from the requested sender or the requested payment account. Similarly, an actual sender can transfer money from an account different from the payment account requested by the receiver by using the identification number, and also the sender can notify the identification number to another person and asks to transfer money from an account of another person.

FIGS. 5 and 6 illustrate the money transfer processing configuration of the sender terminal 5 in the money transfer system 1 according to the first embodiment of the present invention. FIG. 5 illustrates that a sender requested by a receiver transfers money from his/her own account, and FIG. 6 illustrates that money is transferred from an account of another person different from the sender requested by the receiver.

Identically to the network interface of the receiver as shown in FIGS. 2 to 4, the sender also checks details of the transfer request information sent from the receiver to the sender when accessing the bank server 3 through Internet banking, phone banking or ATM banking for banking work, and then transfers a predetermined amount of money in the first embodiment of the present invention.

Referring to FIG. 5, the sender terminal 5 accesses the bank server 3 for banking work (\textcircled{1}), and then the bank server 3 transmits the transfer request information corresponding to the sender to the sender terminal 5 (\textcircled{2}). Then, the sender selects at least one transfer request information and then requests money transfer (\textcircled{3}). Here, the sender can transfer money through the payment account included in the transfer request information, or can transfer money using another account of his/her own. In case the sender selects money transfer, the sender may directly make money transfer based on the selected transfer request information without inputting receiver information and amount of money. A predetermined existing authentication procedure (e.g., certificate, safety card, secret number for transfer, and so on) is executed between the bank server 3 and the sender terminal 5 in order to transfer money (\textcircled{4}).

Referring to FIG. 6, in case the sender requested by the receiver asks another person to transfer money, a sender terminal 5 of the third party accesses the bank server (\textcircled{1}), and inputs the transmitted specific peculiar number to request inquiry (\textcircled{2}). The bank server 3 searches the transfer request information corresponding to the searched peculiar number and provides it to the sender terminal 5, and the sender (the third party) transfers money (\textcircled{4}).

In particular, in case of FIG. 6, unless the third party directly inputs a payer name as the sender requested by the receiver, a name of the third party may be displayed in the money transfer deposit details of the receiver. At this time, the receiver may be configured when checking the payment details using a payer name. However, since the peculiar number endowed in real time when the receiver requests money transfer is displayed in the deposit information of the receiver account in the present invention, it is possible to check money transfer exactly using the peculiar number though a sender name is changed for any money transfer. Thus, the money transfer using a peculiar number of the present invention advantageously allows to rapidly and exactly check deposit details when a lot of money transfers are made like a company (receiver).

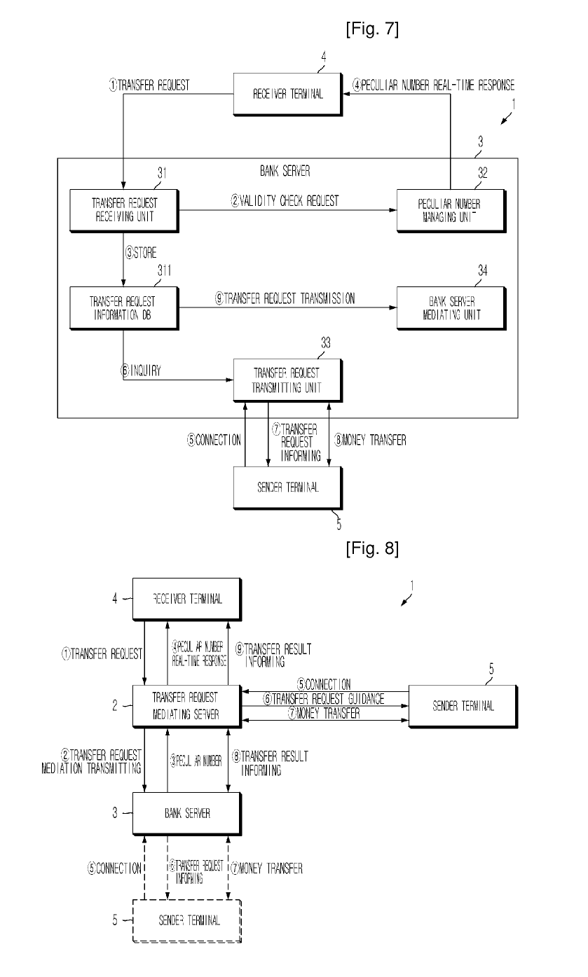

FIG. 7 shows a schematic inner configuration of the bank server 3 according to the first embodiment of the present invention.

The bank server 3 of the first embodiment includes a transfer request receiving unit 31, a peculiar number managing unit 32, and a transfer request information DB 311.

The transfer request receiving unit 31 receives the transfer request information from the receiver terminal 4 (\textcircled{1}). The transfer request information input by a receiver is illustrated in the above Table 1 as an example, in which the receiver may not input the receiver information (e.g., a receiver name, a deposit bank name, and a deposit account number) selectively, and at this time the receiver information should be recorded in the bank server 3 (namely, the bank of the receiver should have personal information and deposit information of the receiver). That is to say, when the receiver accesses the bank server 3 using online banking, the bank server 3 may automatically add a basic account of the receiver to the transfer request information (namely, the receiver may not input his/her own account information but directly inputs the account information only when it is changed. In addition, in case the receiver does not input an amount of money to be deposited (or, an amount of money to be transferred), it is possible that the sender voluntarily inputs an amount of money to be transferred for the money transfer.

The peculiar number managing unit 32 receives a validity test request (\textcircled{2}), and extracts the account information (e.g., a bank name, an account owner, and an account number) included in the transfer request information of the receiver to check whether the account is actually existing.

In the first embodiment of the present invention, it has been illustrated that a receiver requests money using online banking in a his/her main bank, but the present invention is not limited thereto. For example, the receiver may request a money transfer in a sender's main bank not transacted with the receiver, or the receiver may request a money transfer through another bank server 3, if a suitable interface is suitably changed using a business tie-up with a bank.

Thus, the peculiar number managing unit 32 may entrust another bank server 3 to determine validity of the sender account information, and then receives its result. If the account information is determined to be valid, the transfer request information input by the receiver and the peculiar number are stored in the transfer request information DB 311 (\textcircled{3}), and the peculiar number is responded and transmitted to the receiver terminal 4 in real time (\textcircled{4}). In addition, if the validity is confirmed, the bank server 3 may extract informing means information of the sender (e.g., a mobile phone number and an email address) from the transfer request information and then inform of the transfer request. The following table 2 shows an example of data structure of the transfer request information DB 311, but not limitedly.

TABLE 2

| | |
|---|---|
| Transfer request | Receiving information: receiver name + |
| information DB | deposit bank name + deposit account number + |
| | amount for transfer ++ receiver informing means |
| | (email, contact number) Sending information: sender |
| | name + payment bank name + payment account |
| | number + sender informing means (email, contact |
| | number) Other information: peculiar number + transfer |
| | flag |

If accounts of the receiver and the sender are established in the same bank, the transfer request transmitting unit 311 guides the transfer request information when the sender terminal 5 accesses thereto and provides the money transfer service (\textcircled{2}) (\textcircled{3}) (\textcircled{7}) (\textcircled{8}). In particular, the sender checks the transfer request information during the money transfer process, and then selects money transfer without inputting any special information if it is a correct transfer request. The following money transfer procedure is executed using the well known authentication method (using certificate, safety card or secret number for transfer), and not described in detail here. If the money transfer is successfully completed, the transfer flag of Table 2 is set to a success value, and it is informed to the receiver informing means in real time.

If accounts of the receiver and the sender are not established in the same bank, the bank server mediating unit 34 inquires the transfer request information and then transmits it to another bank server 3 in which a payment account of the sender is established.

FIG. 8 shows a schematic configuration of a money transfer system 1 according to a second embodiment of the present invention.

The second embodiment of the present invention further includes a transfer request mediating server 2 in addition to the first embodiment of the present invention. The second embodiment includes all configuration and functions of the first embodiment, except that the transfer request mediating server 2 receives transfer request information of a receiver and guides it to a sender, and receives a money transfer request from the sender to mediate money transfer with respect to the bank server 3. Of course, the second embodiment also includes that a sender directly transfer money through the bank server 3.

The transfer request mediating server 2 receives transfer request information of a receiver and transmits the transfer request to a bank server 3 corresponding to a sender (\textcircled{1}) (\textcircled{2}). If the bank server 3 generates a peculiar number for response as in the first embodiment, the peculiar number is transmitted to the receiver terminal 4 in real time (\textcircled{3}) (\textcircled{4}).

If the transfer request information of the receiver is normally registered, the mediating server 2 preferably informs the send terminal 5 of the transfer request of the receiver through SMS or email.

The sender terminal 5 accesses the mediating server 2 to check the transfer request information provided to his/her and select a money transfer (\textcircled{5}) (\textcircled{6}). For treating the money transfer, the mediating server 2 provides the sender with a predetermined money transfer screen, and mediates data transmission between the sender and the bank server 3 (\textcircled{7}). Meanwhile, the mediating server 2 may provide the money transfer service by linking to a money transfer page of the corresponding bank server 3. If the bank server 3 successfully transfers money, its result is informed to the receiver terminal 4 via the mediating server 2 by means of SMS or email (\textcircled{8}) (\textcircled{9}).

In the second embodiment, it is also possible that the sender accesses the bank server 3 to receive the transfer request information and deposits money to the receiver as in the first embodiment (\textcircled{5}) (\textcircled{6}) (\textcircled{7}).

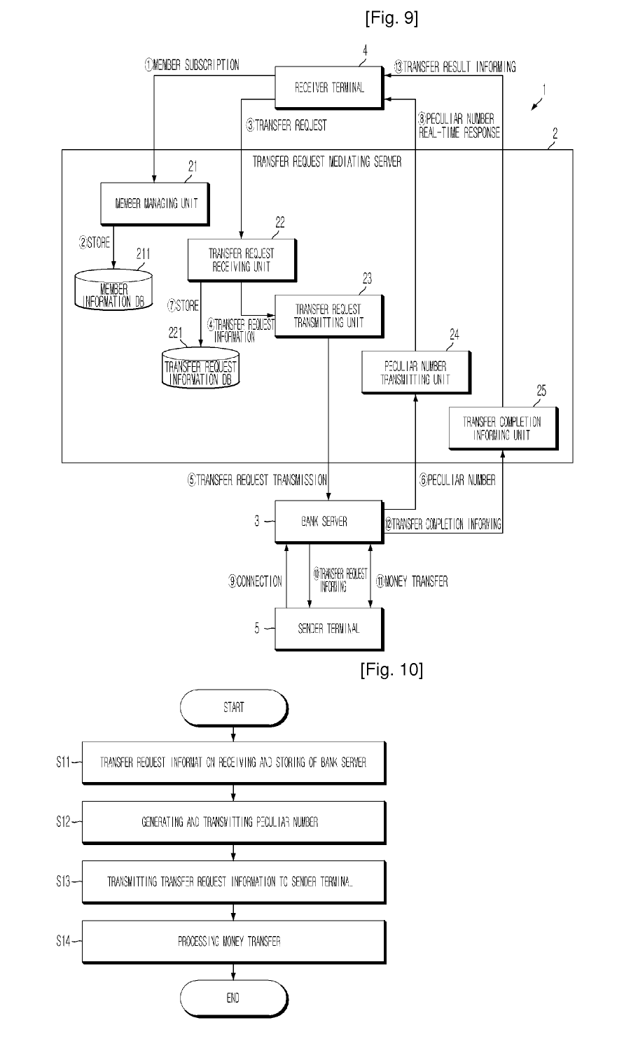

FIG. 9 shows a schematic inner configuration of the transfer request mediating server 2 according to the second embodiment of the present invention.

The mediating server 2 of the second embodiment includes a member managing unit 21, a transfer request receiving unit 22, a transfer request transmitting unit 23, a peculiar number transmitting unit 24, a transfer completion informing unit 25, a member information DB 211, an a transfer request information DB 221. The mediating server 2 is assumed to provide a sender and a receiver with the money transfer service according to a transfer request through a homepage.

The member managing unit 21 guides a user to join as a member according to a pre-determined member subscription procedure from the receiver terminal 4, and stores the member information in the member information DB 211 (\textcircled{1}), (\textcircled{2}). In addition, it is also possible to provide member subscription service to a sender.

If the transfer request receiving unit 22 receives the transfer request information of the receiver (\textcircled{3}), the transfer request transmitting unit 23 extracts the corresponding receiver information and transmits the transfer request information to a corresponding bank server 3 (\textcircled{4}), (\textcircled{5}). The bank server 3 checks validity of the account information, and generates a peculiar number in case of an existing account, and then responds to the peculiar number transmitting unit 24 in real time (\textcircled{6}). The transfer request information is stored in the transfer request information DB 221 together with the peculiar number (\textcircled{7}) (see Table 2), and the peculiar number is transmitted to the receiver terminal as a real-time response (\textcircled{8}).

After that, the sender informed of the transfer request of the receiver from the mediating server 2 in real time accesses the mediating server 2 or the bank server 3 and checks the transfer request information provided to him/her, and then approves a money transfer (\textcircled{9}), (\textcircled{10}), ( [symbol] ). FIG. 9 exemplarily shows that the sender directly accesses the bank server 3 and transfers money therethrough.

If the bank server 3 successfully transfers money, the transfer flag of the transfer request information DB 221 is set to a success value, and its result is informed to the receiver terminal 4 via the transfer completion informing unit 25 by means of email or SMS ( [symbol] , [symbol] ). Of course, it is also possible that the receiver checks the result by accessing a homepage of the mediating server 2.

FIG. 10 shows the entire money transfer method according to the first embodiment of the present invention.

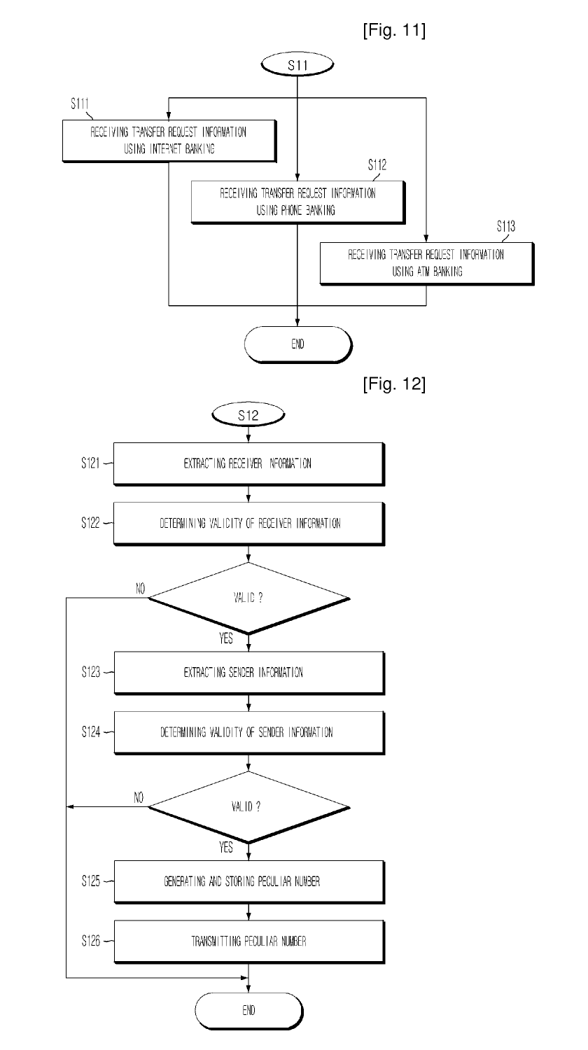

In a transfer request information receiving and storing step (S11), the bank server 3 of the first embodiment receives transfer request information from the receiver terminal 4. Seeing this step in more detail with reference to FIG. 11, the bank server 3 receives the transfer request information from a receiver through any communication means (e.g., computer, PDA, wire/wireless phone, and ATM device) allowing online banking. If the receiver does not input the deposit account information, the bank server automatically registers a main account number of the receiver. In addition, if an amount of money to be transferred is not specified, an amount of money voluntarily input by the sender will be transferred.

In a peculiar number generating and transmitting step (S12) of FIG. 10, the bank server 3 determines whether an account number of the transfer request information is actually existing, and then generates and stores a peculiar number in the transfer request information DB 311 if validity is confirmed. Seeing it in more detail with reference to FIG. 12, in a receiver extracting step (S121), a receiver name, a deposit bank name and a deposit account number are extracted from the transfer request information. In a receiver information validity determining step (S122), the bank server 3 determines existence of the account by comparing it with the already possessed account information. If the account of the receiver is an account of another bank, a corresponding bank server 3 is entrusted to transmit a validity result. If the validity is confirmed, in a sender information extracting step (S123) and a sender information validity determining step (S124), existence of the sender account is determined as in the above steps S121, S122. If the validity is conformed, in a peculiar number generating and storing step (S125), a peculiar number is generated and then stored in the transfer request information DB 311. In addition, in a peculiar number transmitting step (S126), the bank server 3 transmits the peculiar number to a receiver informing means (e.g., mobile phone or email) as a response to the transfer request information.

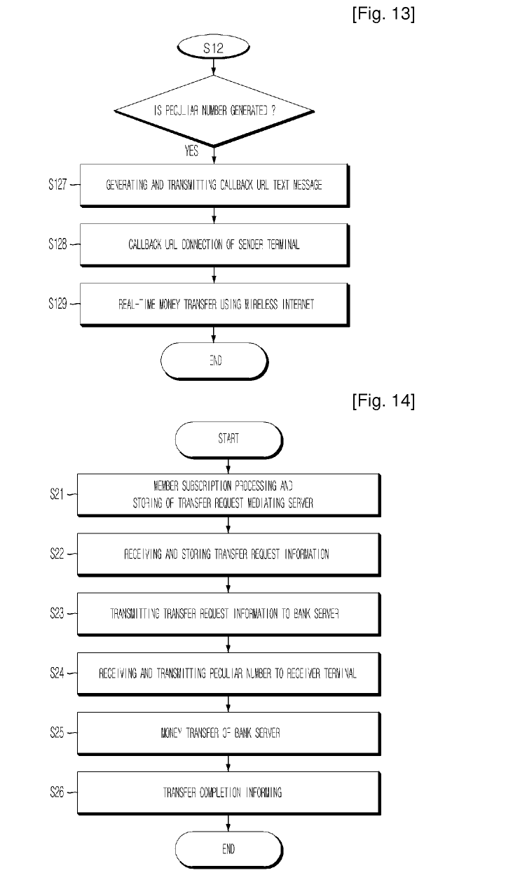

In addition, in the above step S12, it is also possible to inform the sender using a callback URL text message that a transfer request is received. Seeing it in more detail with reference to FIG. 13, in a callback URL text message generating and transmitting step (S127), the bank server 3 receives the transfer request of the receiver and then transmits a call URL SMS message including the transfer request of the receiver and the peculiar number to a mobile terminal of the sender in real time. In a callback URL connecting step (S128), the sender selects a direct connection button to access the bank server 3 using wireless Internet. In a real-time money transferring step (S129), the sender receives the current transfer request information and then pushes a conformation button to approve money transfer. It may suggest a payment pattern in which a user (a sender) purchases an article in an offline market and says his/her own terminal number and account number, and then a host (or, a receiver) registers a transfer request directly at the spot so that the user pays for the article in real time.

In a transfer request information transmitting step (S13) to the sender terminal of FIG. 10, the bank server 3 searches the entire transfer request information including an account number of the sender from the transfer request information DB 311 and then transmits it to the accessed sender terminal 5. It may be conducted when a payment account and a deposit account are established in the current bank server 3. If a payment account is established in another bank, the current bank server 3 (a bank server receiving the transfer request information) transmits the transfer request information to another bank server of the sender. Similarly, the sender accesses the bank server 3 using online banking and checks the transfer request information to transfer money.

In a money transferring step (S14), the bank server 3 transfers money according to the transfer request information selected by the sender. Here, the money transfer can be made just using selection of money transfer and well-known authentication process of the sender without inputting any sender information and receiver information by the sender.

In the money transfer method according to the first embodiment, the sender may deposit money selecting another account, not a payment account requested by the receiver, and it is also possible that a third party deposits money in response to the transfer request information searched using a peculiar number in favor of the sender. In this case, though a money is deposited not from the originally requested payment account of the sender but from another account or from an account of another person, the receiver may conveniently check the money transfer using the received peculiar number.

FIG. 14 shows the entire money transfer method according to the second embodiment of the present invention. The money transfer method of the second embodiment uses the transfer request mediating server 2 described above.

In a member subscription processing and storing step (S21), the mediating server 2 guides a user (sender and receiver) to join as a member, and receives the entire account information possessed by the user. The user may register information of all bank accounts regardless of banks, and sets a specific account of them as a basic account. Here, the basic account may be designated as a default account by the mediating server 2 when a receiver gives a transfer request without inputting a deposit account.

A transfer request information receiving and storing step (S22), the mediating server 2 receives the transfer request information from the receiver terminal 4 and then stores it in the transfer request information receiving DB 221.

In a transfer request information transmitting step (S23), the mediating server 2 extracts the sender information and transmits the transfer request information to the corresponding bank server 3.

In a peculiar number receiving and transmitting step (S24), the bank server 3 extracts account information of the receiver and the sender from the received transfer request information to check existence of the accounts, and then generates and transmits a peculiar number if the validity is confirmed, and then the mediating server 2 then transmits the peculiar number to the receiver terminal 4 as a real-time response.

In a money transfer processing step (S25) of the bank server, the bank server 3 informs a user accessing the bank server 3 using online banking that the transfer request is received, and then transfers money to a deposit account of the corresponding receiver if the sender selects the money transfer.

In a money transfer completion informing step (S26), the money transfer result transmitted from the bank server 3 is informed to an informing means of the receiver.

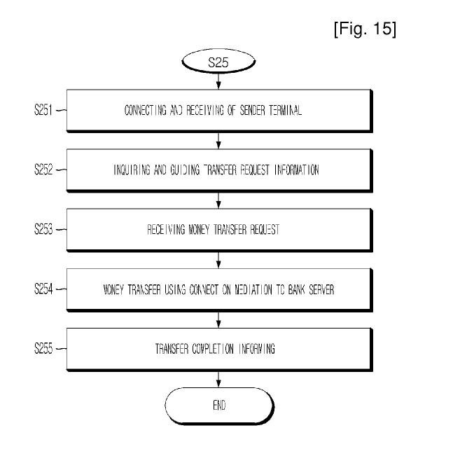

In addition, in the second embodiment, the mediating server 2 may process logging-in directly from a receiver and then guides the transfer request so as to mediate the money transfer process from the bank server 3. Seeing FIG. 15, in a sender terminal connection receiving step (S241), the mediating server 2 processes logging-in of the sender terminal 5. In a transfer request information inquiring and guiding step (S242), the entire accounts of a current user are inquired from the member information DB 211, and the transfer request information DB 221 is also inquired for each account to search any transfer request information designated to a payment account of the sender, and then this transfer request information is guided to the sender terminal 5. In a transfer request receiving step (S243), a transfer request is received for the sender, and the mediating server 2 mediates transfer data between the sender terminal 5 and the bank server 3 through a money transfer processing step (S244). In a money transfer completion informing step (S245), the bank server 2 informs the receiver informing means of a money transfer result transmitted from the bank server 3.

A money transfer system for transferring money based on approval of a sender for a transfer request transmitted from a receiver, and a money transfer method using the same have been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

The money transfer system for transferring money based on approval of a sender for a transfer request transmitted from a receiver, and a money transfer method using the same according to the present invention may reduce time taken for the money transfer process and allow exact and safe money transfer service since a sender checks a money transfer request of a receiver and then determines whether or not to transfer money.

In addition, the receiver may request payment by inputting transfer request information, instead of requesting payment offline to a sender, and the receiver may easily check money transfer using a peculiar number endowed to each money transfer request.

In addition, the sender and the receiver may pay in real time using a real-time transfer request and money transfer using a URL callback message.

1-18. (canceled)

19. A money transfer system for transferring money based on approval of a sender for a transfer request transmitted from a receiver on on-line banking (including Internet banking, phone banking, ATM (Automatic Teller Machine) banking and mobile banking), the system comprising:
a receiver terminal for transferring transfer request information including receiving information and sending information;
a bank server for extracting the sending information from the transfer request information transmitted from the receiver terminal to guide the transfer request information to a corresponding sender, and transferring a predetermined amount of money from a payment account of the sender to a deposit account of the receiving information when the sender checks the transfer request information and approves the money transfer; and
a sender terminal for accessing the bank server to receive and display the transfer request information of the receiver, and transmitting an approval for the money transfer to the deposit account of the receiver included in the transfer request information.

20. The money transfer system according to claim 19, wherein the bank server receives the transfer request information, endow a peculiar number, and responds to the peculiar number in real time so that the receiver is capable of checking receipt of money using the peculiar number though the sender transfers money to another payment account or another sender transfers money based on inquiry of the peculiar number.

21. The money transfer system according to claim 19, wherein the bank server includes:
a transfer request receiving unit for receiving the transfer request information through a network;
a peculiar number managing unit for generating a peculiar number after checking validity of the transfer request information, and transmitting a real-time response to the peculiar number; and
a transfer request transmitting unit for transmitting all transfer request information to the sender when the sender terminal of the sender accesses thereto.

22. The money transfer system according to claim 19, wherein the bank server further includes: a bank server mediating unit for transferring the transfer request information to a bank server of the sender corresponding to the transfer request information in case the bank server of the receiver receives the transfer request information and extracts the sending information to fine that the bank server of the sender is different from the bank server of the receiver.

23. The money transfer system according to claim 19, wherein, in case the bank server transmits the transfer request information without receiving a deposit account from the receiver, a basic deposit account previously registered in the transfer request information by the receiver is automatically registered, and wherein, in case the bank server transmits the transfer request information without receiving an amount of money to be transferred, the sender voluntarily determines an amount of money to be transferred.

24. A money transfer system for transferring money based on approval of a sender for a transfer request transmitted from the receiver on on-line banking (including Internet banking, phone banking, ATM banking and mobile banking), the system comprising:
a receiver terminal for transferring transfer request information including receiving information and sending information;
a transfer request mediating server for guiding a receiver to join as a member, and extracting the sending information from the transfer request information transmitted from the receiver terminal logged in and mediating so that the transfer request information is transmitted to a payment bank of a corresponding sender;
a bank server for extracting the sending information from the transfer request information transmitted from the transfer request mediating server to guide the transfer request information to the corresponding sender, and transferring a predetermined amount of money from a payment account of the sender to a deposit account of the receiving information when the sender checks the transfer request information and approves the money transfer; and
a sender terminal for accessing the bank server to receive and display the transfer request information of the receiver, and transmitting an approval for the money transfer to the deposit account of the receiver included in the transfer request information.

25. The money transfer system according to claim 24, wherein the bank server receives the transfer request information, endow a peculiar number, and responds to the peculiar number in real time so that the receiver is capable of checking receipt of money using the peculiar number though the sender transfers money to another payment account or another sender transfers money based on inquiry of the peculiar number.

26. The money transfer system according to claim 24, wherein the bank server includes:
a transfer request receiving unit for receiving the transfer request information through a network;
a peculiar number managing unit for generating a peculiar number after checking validity of the transfer request information, and transmitting a real-time response to the peculiar number; and
a transfer request transmitting unit for transmitting all transfer request information to the sender when the sender terminal of the sender accesses thereto.

27. The money transfer system according to claim 25, wherein the bank server further includes: a transfer request information DB (database) for storing the transfer request information including the receiving information (including a receiver name and a deposit account number), the sending information (including a sender name and a payment account number), an amount of money to be transferred, the peculiar number and a transfer flag.

28. The money transfer system according to claim 24, wherein, in case the bank server transmits the transfer request information without receiving a deposit account from the receiver a basic deposit account previously registered in the transfer request information by the receiver is automatically registered, and wherein, in case the bank server transmits the transfer request information without receiving an amount of money to be transferred, the sender voluntarily determines an amount of money to be transferred.

29. The money transfer system according to claim 24, wherein the transfer request mediating server includes:
a member managing unit for processing a member subscription request from the receiver terminal, and storing account information of the receiver;
a transfer request receiving unit for receiving the transfer request information from the receiver terminal;
a transfer request transmitting unit for transmitting the transfer request information to the bank server of the sender corresponding to the transmitted transfer request information; a peculiar number mediating unit for receiving the peculiar number from the bank server in response to a normal registration of the transfer request information and transmitting the peculiar number to the receiver terminal; and
a transfer completion informing unit for receiving a money transfer result of the sender from the bank server and informing the receiver terminal that the money transfer is completed.

30. The money transfer system according to claim 24, wherein the transfer request mediating server further includes: a member information DB for storing member information of subscribed users and at least one account information; and a transfer request information DB for storing the transfer request information including the receiving information (including a receiver name and a deposit account number), the sending information (including a sender name and a payment account number), an amount of money to be transferred, the peculiar number and a transfer flag.

31. The money transfer system according to claim 29, wherein the transfer request mediating server further includes: a member information DB for storing member information of subscribed users and at least one account information; and a transfer request information DB for storing the transfer request information including the receiving information (including a receiver name and a deposit account number), the sending information (including a sender name and a payment account number), an amount of money to be transferred, the peculiar number and a transfer flag.

32. A money transfer method for transferring money based on approval of a sender for a transfer request transmitted from a receiver on on-line banking (including Internet banking, phone banking, ATM banking and mobile banking), the method comprising:
(S11) a bank server receiving transfer request information including receiving information and sending information from a receiver terminal and storing the transfer request information in a transfer request information DB;
(S12) the bank server generating a peculiar number based on inquiry of validity of the transfer request information, and transmitting the peculiar number to the receiver terminal;
(S13) a sender terminal inquiring the transfer request information DB using all account numbers possessed by a sender when accessing the bank server so that details of the transfer request information are transmitted thereto; and
(S14) transmitting a predetermined amount of money from a payment account of the sender to a deposit account of the receiving information the sender terminal in case the sender terminal selects and approves at least one transfer request.

33. The money transfer method according to claim 32, wherein, in the step (S12), in case the bank server checks an account owner and an account number included in the transfer request information and confirms validity, the bank server generates the peculiar number, stores the peculiar number in the transfer request information DB, and transmits the peculiar number to the receiver terminal.

34. The money transfer method according to claim 32, wherein, in the step (S12), in case payment account information included in the transfer request information is for another bank, the bank server transmits the transfer request information to a corresponding bank server.

35. The money transfer method according to claim 32, wherein the step (S12) further includes a real-time payment step in which the bank server receives the transfer request information that is valid, transmits a callback URL (Uniform Resource Locator) text message allowing one-click connection to a money transfer page of the bank server to a mobile terminal of the sender included in the transfer request information, and transfers a predetermined amount of money to a deposit account of the receiver by means of real-time money transfer from the mobile terminal.

36. The money transfer method according to claim 33, wherein the step (S12) further includes a real-time payment step in which the bank server receives the transfer request information that is valid, transmits a callback URL (Uniform Resource Locator) text message allowing one-click connection to a money transfer page of the bank server to a mobile terminal of the sender included in the transfer request information, and transfers a predetermined amount of money to a deposit account of the receiver by means of real-time money transfer from the mobile terminal.

37. The money transfer method according to claim 34, wherein the step (S12) further includes a real-time payment step in which the bank server receives the transfer request information that is valid, transmits a callback URL (Uniform Resource Locator) text message allowing one-click connection to a money transfer page of the bank server to a mobile terminal of the sender included in the transfer request information, and transfers a predetermined amount of money to a deposit account of the receiver by means of real-time money transfer from the mobile terminal.

38. The money transfer method according to claim 32, wherein, in the step (S13), when the sender terminal accesses the bank server through Internet banking, phone banking or ATM banking, the sender terminal informs details of the transfer request information requested to the sender on an initial screen.

39. The money transfer method according to claim 32, wherein, in the step (S14), in case the sender terminal checks the transfer request information and transmits approval of money transfer, the bank server receives predetermined authentication information (including certificate, secret number for transfer, and safety card) from the send terminal and then transfers money using the authentication information without requiring the sender to input an account number of the receiver.

40. A money transfer method for transferring money based on approval of a sender for a transfer request transmitted from a receiver on on-line banking (including Internet banking, phone banking, ATM banking and mobile banking), the method comprising:
(S21) a transfer request mediating server processing a member subscription request from the receiver terminal, and storing member information and at least one receiver account information in a member information DB;
(S22) the transfer request mediating server receiving transfer request information including receiving information and sending information from a logged-in receiver terminal, and storing the transfer request information in a transfer request information DB;
(S23) extracting the sending information from the transfer request information, and transmitting the transfer request information to a bank server of a corresponding sender;
(S24) receiving a peculiar number from the bank server, and informing the peculiar number to the receiver terminal as a result of transfer request registration;
(S25) the bank server guiding the transfer request information to an accessed sender terminal to transfer money from the sender; and
(S26) receiving a money transfer completion result for a specific peculiar number from the bank server, storing the completion result in the transfer request information DB, and informing the receiver terminal of the completion result.

41. The money transfer method according to claim 40, wherein, in the step (S24), after receiving the peculiar number from the bank server, the transfer request mediating server transmits all transfer request information corresponding to the sender when a member-subscribed sender terminal logs in, and, in case the sender selects at least one transfer request information and requests money transfer, the transfer request mediating server mediates money transfer between the sender terminal and a corresponding bank server.

42. The money transfer method according to claim 40, wherein the step (S25) further includes a real-time payment step in which, after receiving the peculiar number from the bank server, the transfer request mediating server transmits a callback URL text message, which allows one-click connection to a money transfer page of the bank server corresponding to a payment account of the sender, to a mobile terminal of the sender included in the transfer request information, and transfers a predetermined amount of money to a deposit account of the receiver by means of real-time money transfer of the mobile terminal.
